(19) United States
(12) Patent Application Publication
(10) Pub. No.: US 2021/0298989 A1
(43) Pub. Date: Sep. 30, 2021

(54) BROWSER-BASED HAPTIC STIMULATION CONTROL

(71) Applicant: MB Technologies LLC, Sanford, NC (US)

(72) Inventor: John Pounders, Nashville, TN (US)

(21) Appl. No.: 17/213,926

(22) Filed: Mar. 26, 2021

Related U.S. Application Data
(60) Provisional application No. 63/001,219, filed on Mar. 27, 2020.

(51) Int. Cl. A61H 19/00; A61H 7/00; A61H 23/02

(52) U.S. Cl. CPC A61H 19/44; A61H 7/00; A61H 23/02; A61H 2201/5043; A61H 2201/5035; A61H 2201/5041; A61H 2201/5012

(57) ABSTRACT

A user of a haptic stimulation device may control the performance of the device using a control application connected to the device via a short range wireless communication protocol. The haptic stimulation device user may request, through the control application, remote control of the haptic stimulation device by a user of a web browser. The control application may then request a unique web browser session key for a web page with controls for the haptic stimulation device. Once the control application has received the requested session key, the session key may be provided to the web browser user in any manner that is convenient (e.g., via e-mail). The control application may then receive a command, from the web browser user via the controls on the web page, to perform a selected haptic stimulation effect or haptic stimulation routine. The control application may then control the haptic stimulation device performance accordingly.

### CROSS-REFERENCE TO RELATED APPLICATION

This application claims the benefit of and priority to US provisional application Ser. No. 63/001,219, filed on Mar. 27, 2020, the content of which is hereby incorporated by reference in its entirety.

### TECHNICAL FIELD

The present disclosure generally relates to methods and systems for remotely controlling a sexual stimulation device. More particularly, the present disclosure relates to using a web browser to control the performance of the sexual stimulation device.

### BACKGROUND

The remote control of an electromechanical device via wireless control signals may involve a set of servos and/or motors that operate the electromechanical device in response to the control signals. The behavior of the electromechanical device may be controlled by a nearby electronic device (e.g., a smartphone), for example, by connection to the sexual stimulation device using a wireless communication protocol. A user of the smartphone may generate control signals for the electromechanical device by, for example, manually adjusting a variety of controls (e.g., slide bars) on a control panel provided by the nearby electronic device (e.g., shown on a display of the nearby smartphone). The electromechanical device may take the form of a sexual stimulation device designed to soothe and/or stimulate areas of the human body.

The tele-operation of sexual stimulation devices (e.g., sex toys) is often referred to as “teledildonics” (also as “cyberdildonics”). Teledildonics includes technology for remote sexual stimulation (e.g., remote masturbation), wherein the particulars of a tactile stimulation effect (different intensities, different durations, a variety of pulses, etc.) are communicated over a data link to the sexual stimulation device. Sexual stimulation devices may then be remotely controlled by a first user (the “controller”) to stimulate a second user that requests it (the “requester”). Accordingly, the term “controller” refers to the user(s) controlling the sexual stimulation device, and the term “requester” refers to the user(s) requesting remote control of the sexual stimulation device. It is to be understood that the controller and the requester may be the same or different parties.

### BRIEF DESCRIPTION OF THE DRAWINGS

FIG. 1 is a block diagram of a system for browser-based control of a haptic stimulation device, according to embodiments of the present disclosure.

FIGS. 2A-2B are use cases of a system for browser-based control of a haptic stimulation device, according to embodiments of the present disclosure.

FIGS. 3A-3B are use cases of a system for browser-based control of a haptic stimulation device, according to embodiments of the present disclosure.

FIG. 4 is a flow diagram of a method for browser-based control of a haptic stimulation device, according to embodiments of the present disclosure.

FIG. 5 is a flow diagram of a method for browser-based control of a haptic stimulation device, according to embodiments of the present disclosure.

FIG. 6 is a block diagram of a computer system operating in accordance with one or more embodiments of the present disclosure.

### DETAILED DESCRIPTION

Provided are methods and systems that permit a controller to use a web browser to control a sexual stimulation device used to stimulate a requester that may be remotely located from the controller, e.g., outside of the range of short range wireless communication protocols like Bluetooth®. Furthermore, the controller may stimulate the requester over currently existing communication networks, such as the Internet. The requester may use first user interface controls (e.g., via a control application on a smartphone) to connect with the sexual stimulation device that is usable by the requester (e.g., the requester is in range to physically use the device) and then invite the controller to control the sexual stimulation device via second user interface controls (e.g., on a web page accessed via the web browser). The first and second user interface controls may be connected through the web page via the Internet. The second user interface controls described above reside completely within a web browser and, therefore, any computing device with a web browser (smartphone, laptop, tablet, etc.) may remotely control the sexual stimulation device, even at long range. Accordingly, the controller is not required to download and install any software onto their computing device in order to control the sexual stimulation device.

### System

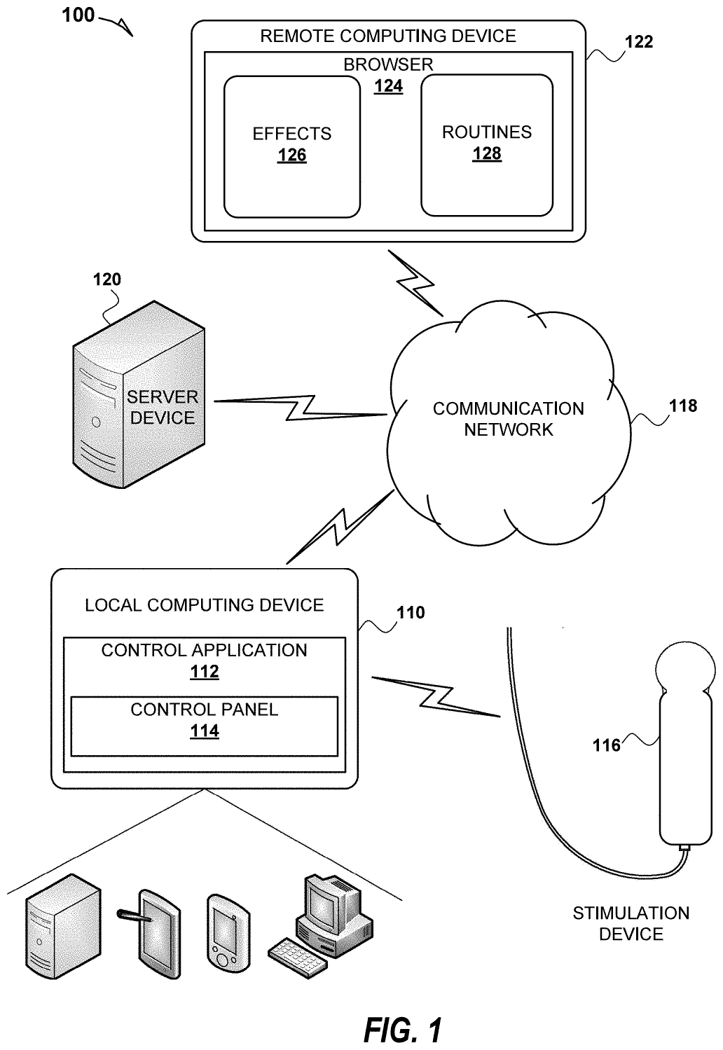

FIG. 1 is a block diagram of a system 100 for browser-based control of a haptic stimulation device 116, according to embodiments of this disclosure.

In example system 100, a web browser 124 may be used to control a haptic stimulation device 116. In some embodiments of the present disclosure, the system 100 may include a local computing device 110 (e.g., a smartphone of the requester) running a control application 112 which may display a control panel 114 for connecting to (e.g., via wireless connection) and/or controlling at least one user sexual stimulation device 116 (e.g., a vibrator or a wearable device), and a communication network 118 (e.g., Internet over wireless home network or telephone cell network). In some embodiments, computing device 110 may take the form of a desktop computing device, a handheld device, a personal digital assistant (PDA), a tablet device, a laptop device, a server, or a handheld navigation system. The system 100 may also include a server device 120 which may receive a session request from control application 112 and return a session key to the control application 112 for transmission to a user of a web browser (e.g., the controller).

The system 100 may also include a remote computing device 122 (e.g., a desktop device of the controller) which may receive the session key (e.g., a unique uniform resource locator (URL)) and use web browser 124 to display a web page (e.g., hosted by server device 120) with controls for haptic stimulation effects 126 and haptic stimulation routines 128 for controlling stimulation device 116. The control panel 114 of control application 112 may mirror the controls 126 and routines 128 controls for haptic stimulation effects 126 and haptic stimulation routines 128 so that they may be viewed and/or interacted with by the requester. Commands received from the controller, via the controls for effects 126 and/or routines 128 of the web page hosted by server device 120, may then be transmitted to control application 112 for control of haptic stimulation device 116 to perform the effects 126 and/or routines 128 selected by the controller.

Alternatively, the selection of the stimulation effect and/or haptic stimulation routines performed by haptic stimulation device may be overridden (e.g., by local computing device 110) via a user configuration (e.g., a threshold level of stimulation) or via a known limitation of the haptic stimulation device 116, for example, the haptic stimulation device 116 may not have the capability to perform a particular haptic stimulation effect.

### Use Cases

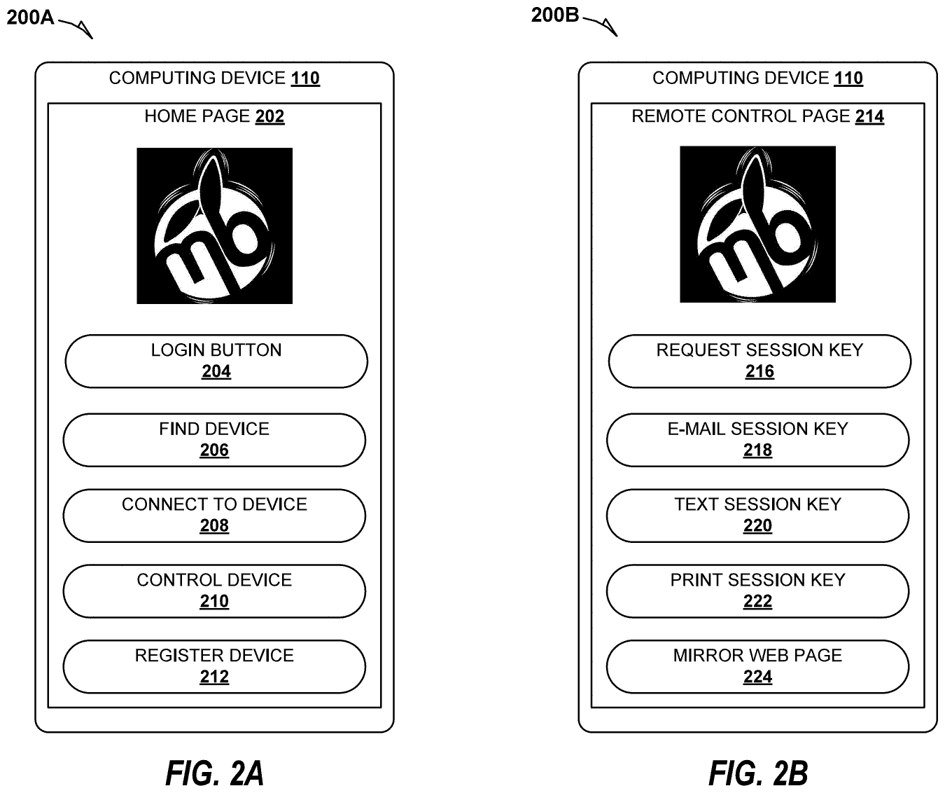

FIGS. 2A-2B are use cases 200A and 200B of the system 100 for browser-based control of the haptic stimulation device 116, according to embodiments of the present disclosure

As shown in the use case of FIG. 2A, the requester may use computing device 110 to run the control application 112 and access control panel 114 via a “home” page 202. The requester may then use a “login” button 204 to log in (or sign in) to the control application 112 which may provide the requester with, for example, quick access to information about known (e.g., registered) haptic stimulation device(s) 116 of the requester. This information may be used, for example, to provide a quick connection to the registered haptic stimulation device or to provide controls for effects 126 and/or routines 128 that are suited to the capabilities of the device.

Additionally, the requester may then use a “find device” button 206 to search for nearby haptic stimulation devices 116 capable of connecting with the control application 112 (e.g., via a Bluetooth® connection). The control application 112 may then present the requester with a list of the found haptic stimulation device(s) 116 available for connection to the control application 112.

Based on the control application 112 finding a haptic stimulation device 116 that has not been registered, the requester may then use a “register device” button 212 to register the found unregistered stimulation device 116.

The requester may then select a haptic stimulation device 116 from the list of devices available for connection by using a “connect to device” button 208 and the control application 112 may then connect with the selected stimulation device 116 (e.g., via a wireless communication protocol).

The requester may then access controls (e.g., the control panel 114) that are appropriate for the connected haptic stimulation device 116 by using a “control device” button 210. In some embodiments, the mobile application 112 may display the control panel 114 to the requester in an “unconnected” mode (e.g., not connected to any nearby device) so that the requester may simply tour the features of the control panel 114 (e.g., slide bar controls for haptic stimulation effects). In some embodiments, the control panel 114 may comprise a button, a switch, a slider, or other graphical control element, any of which may be activated via a mouse, a keyboard, a touchscreen, a trackball or any combination thereof.

As shown in the use case of FIG. 2B, the requester may also use the “control device” button 210 to access a “remote control” page 214. The requester may then use a “request session key” button 216 to request a remote sexual stimulation session from server device 120. The control application 112 may request the remote sexual stimulation session via the communication network 118. The server device 120 may then generate a sexual stimulation web browser “session key” and return it to the control application 112 in response to the session key request. The session key may comprise a URL ending with a unique sequence that serves as the key for verification of the controller.

The requester may then communicate the session key to the remote computing device 122 of the controller so that the sexual stimulation device 116 may be remotely controlled by the controller. The requester may communicate the session key URL in any manner, for example the session key may be transmitted via communication network 118 (e.g., via an e-mail, an SMS message, Kik Messenger, etc.) by using an “e-mail session key” button 218, and/or “text session key” button 220. Alternatively, the requester may even communicate the session key directly (e.g., manually, verbally or visually) to the controller if they are available for direct communication (e.g., physically close enough to the requester). Still further, the requester may print the session key by using a “print session key” button 222 if that is a preferred method of communication.

In some embodiments, the controller may then use remote computing device 122 (e.g., a laptop device of the controller) to enter the session key URL into web browser 124 in order to access a web page, hosted by server device 120, which provides controls for haptic stimulation effects 126 and/or haptic stimulation routines 128 for remotely controlling the sexual stimulation device 116. The controls for haptic stimulation effects 126 and/or haptic stimulation routines 128 may comprise controls for effects and routines like those described above with respect to control panel 114 of control application 112. In fact, the control panel 114 of control application 112 may mirror the controls for haptic stimulation effects 126 and/or haptic stimulation routines 128 of the web page hosted by the server device 120 once they are provided to the controller via web browser 124 of the remote computing device 122. The requester may request that the control application 112 mirror the controls for effects 126 and/or routines 128 of the web page by using a “mirror web page” button 224.

The controller may then remotely control sexual stimulation device 116 via the controls for effects 126 and/or routines 128 as described above. Furthermore, the controls may also provide the controller and the requester with the ability to end the remote sexual stimulation session via control panel 114 of control application 112 or web browser 124 of remote device 122.

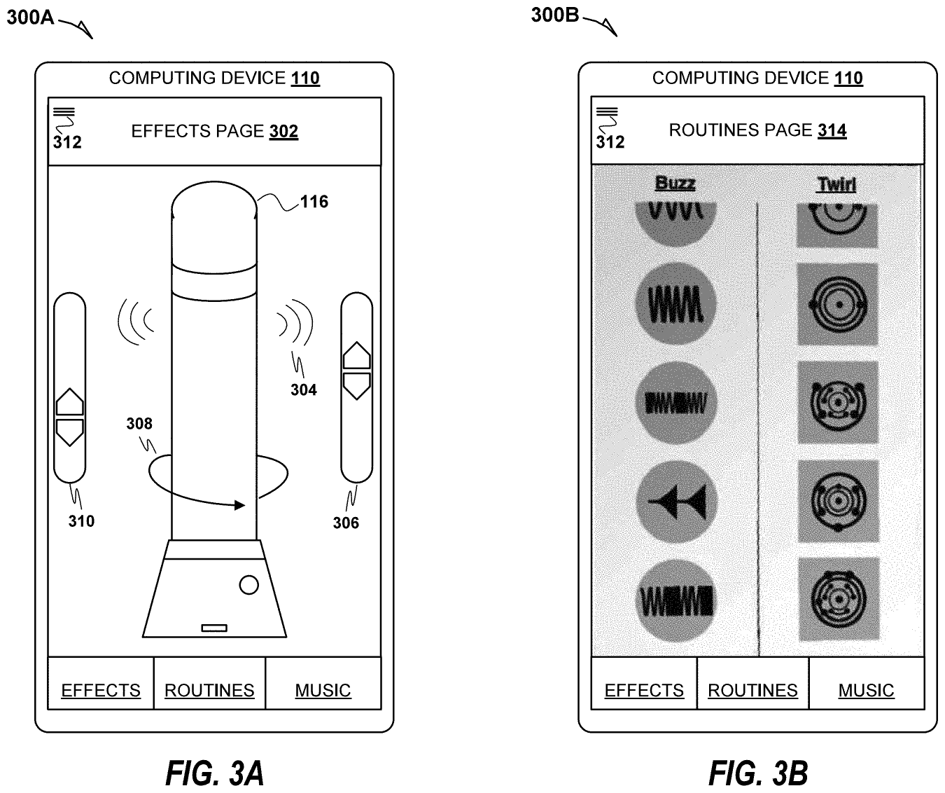

FIGS. 3A-3B are use cases 300A and 300B of the system 100 for browser-based control of the haptic stimulation device 116, according to embodiments of the present disclosure.

As shown in the use case of FIG. 3A, the requester may use the “control device” button 210 and/or the controller may use the controls on web browser 124 to access an “effects page” 302 for selecting/controlling the haptic stimulation effects 126 for execution by the haptic stimulation device 116. As noted above, the sexual stimulation device 116 may be configured to provide one or more distinct sexual stimulation effects. The “effects page” 302 may show an image corresponding to a haptic stimulation device 116 of the requester that has been found and/or previously registered, as described above with respect to FIGS. 2A and 2B. The image corresponding to the haptic stimulation device 116 on the “effects page” 302 may indicate (e.g., visually) the haptic stimulation effect capabilities of the found/registered haptic stimulation device 116. For example, the “effects page” 302 may indicate that the haptic stimulation device 116 has the ability to perform vibrations 304 and/or twirls 308.

For this purpose, the “effects page” 302 may also include slide bar controls for the separate motors of the haptic stimulation device 116, such as a “Buzz” slide bar 306 to control the speed of the motor for the vibrations 304 of the haptic stimulation device 116. Furthermore, the effects page 302 may also include a “Twirl” slide bar 310 to control the speed of the motor for the twirls/spins 308 of the haptic stimulation device 116. In some embodiments, the distinct sexual stimulation effects to be executed by haptic stimulation device 116 may include vibrations, thrusts, twirls, suctions or other such tactile stimulation effects.

In some embodiments, the slide bar controls for separate motors may provide controls for sexual stimulation effect parameters such as intensity, pattern, duration, etc., to be used by the sexual stimulation device 116 to execute a specific sexual stimulation effect. These parameter controls may be used by the requester and/or the controller to create their own custom haptic stimulation routines that may be performed by the haptic stimulation device in addition to the routines already provided by the control application 112 and/or the controls on the web page hosted by server device 120.

A toggle menu icon 312 may be used to access other menu items of control application 112 and/or the controls of web browser 124, e.g., the “home” page 202 or the “remote control” page 214. The “effects” page 302 and the “routines” page 314 may also be accessed via dedicated “effects” and “routines” buttons at the bottom of the pages for controlling the performance of haptic stimulation device(s) 116. The button corresponding to the currently viewed page (e.g., effects page 302) may be highlighted or darkened to show that it is the currently viewed page or that that button is not available for selection respectively. In some embodiments, a dedicated “music” button may be provided so that music (e.g., played through microphone(s) of computing device 110) may be coordinated with the execution of stimulation effects and/or stimulation routines by the haptic stimulation device 116.

As shown in the use case of FIG. 3B, the requester may use the control device button 210 and/or the controller may use the controls on web browser 124 to access a routines page 302 for selecting/controlling the haptic stimulation routines 128 for execution by the haptic stimulation device 116. As noted above, the sexual stimulation device 116 may be configured to provide one or more distinct sexual stimulation routines associated with one or more of the haptic stimulation effects 126.

For this purpose, the routines page 314 may also include dedicated lists for routines that are compatible with the haptic stimulation effect capabilities of the haptic stimulation device 116. For example, FIG. 3B shows separate “Buzz” and “Twirl” lists corresponding to the separate motors of the haptic stimulation device 116. The requester and/or controller may select one or more routines from these lists for execution by the haptic stimulation device 116. These routines may enable the requester and/or controller to select a “recorded” set of controls for execution by the sexual stimulation device 116. The routines allow for complex combinations and/or patterns of control signals for the haptic stimulation device 116 and may also allow for the execution of these complex combinations and patterns at speeds that may be difficult or impossible for a user to achieve in real time using the control slide bars of effects page 302, as described above.

### Methods

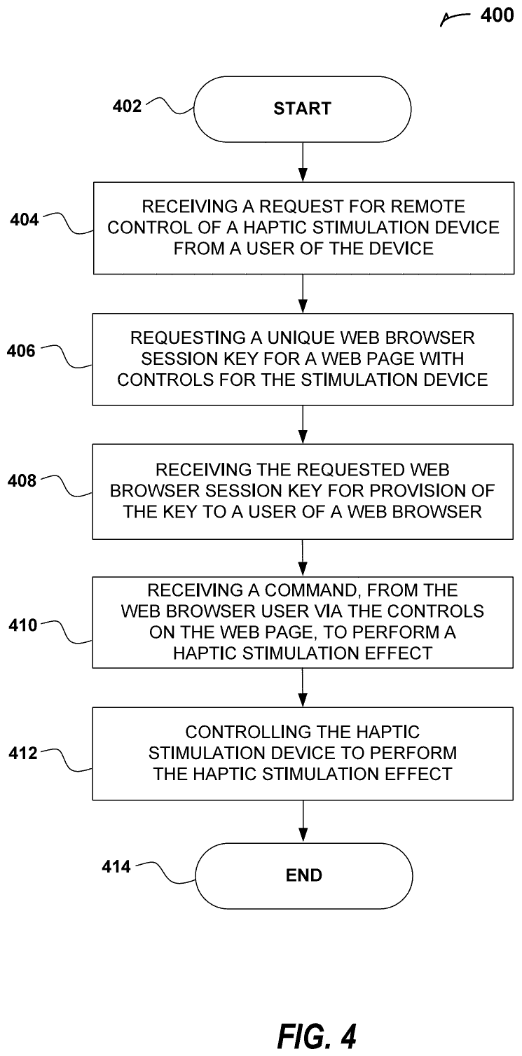

FIG. 4 is a flow diagram of a method 400 for browser-based control of a haptic stimulation device 116, according to embodiments of the present disclosure.

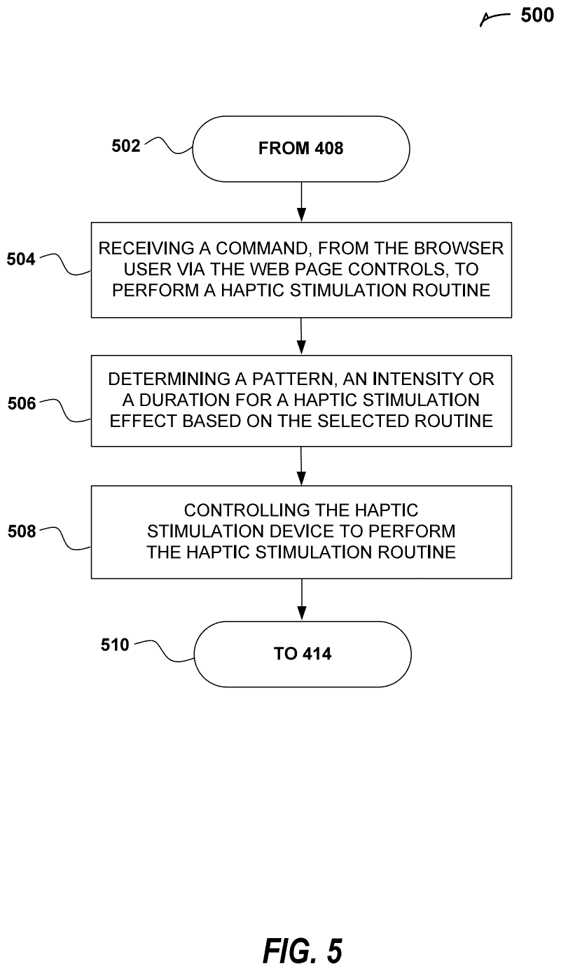

In some embodiments, the operations of FIG. 4 and FIG. 5 may be implemented in program code that is executed by at least one processor, for example, the processor(s) in a general purpose computer or a mobile computing device (e.g., local computing device 110 of FIG. 1). To help understand how each of the operations of method 400 and method 500 might be performed, the following description is provided in the context of the element numbers of the example system 100 as shown in FIG. 1, FIG. 2 and FIG. 3. However, it is understood that embodiments according to the present disclosure may be implemented with any combination of alternative elements.

At operation 402, initial operations for browser-based control of the haptic stimulation device 116 may be started.

As noted above, the control application 112 (running on local computing device 110) may search for sexual stimulation devices to connect with. The control application 112 may use a wireless connection protocol (e.g., Bluetooth®) to detect nearby sexual stimulation devices and may also display (e.g., via a display of local computing device 110) any detected sexual stimulation devices to the requester for selection. The requester may select a detected sexual stimulation device for connection. The control application 112 may then connect with the selected sexual stimulation device (e.g., stimulation device 116 of FIG. 1).

The control application 112 may display a control panel 114 for controlling the selected sexual stimulation device 116. As described above, the control panel 114 may provide controls and/or routines which may be selected to control the behavior of the sexual stimulation device 116.

At operation 404, a request for remote control of the haptic stimulation device 116 may be received from a user of the haptic stimulation device 116, e.g., a requester may use control application 112 to access “remote control” page 214 and use the “request session key” button 216.

At operation 406, the control application 112 may transmit the request for a web browser session key to the server device 120, e.g., via communications network 118 of FIG. 1.

At operation 408, the requested web browser session key may be generated by the server device 120 and transmitted to the control application 112 so that the requester may then provide the key to a user of a web browser (e.g., the controller) so that the controller may access the web page hosted by server device 120 with controls for haptic stimulation device 116.

As described above, the session key may comprise a unique URL. Also as noted above, the server device 120 may transmit the session key to the control application 112 via communication network 118. The control application 112 may display the unique session key URL to the requester on a display of local computing device 110. The requester may communicate the session key to the controller via any means (e.g., via the “text session key” button 220 to message over communication network 118 or via speech if the controller is nearby) with a request for the controller to remotely control the behavior of haptic stimulation device 116 (e.g., a sexual stimulation device).

At operation 410, a command to perform a haptic stimulation effect may be received from the controller via the controls for haptic stimulation effects 126 and/or haptic stimulation routines 128 on the web page hosted by server 120.

The controller may enter the unique URL into web browser 124 of remote computing device 122 which may be connected to the internet via communication network 118. The web browser 124 may load the remote sexual stimulation web page hosted by server device 120 in order to access the controls for haptic stimulation effects 126 and/or haptic stimulation routines 128 for the haptic stimulation device 116. The controller may then use the controls to command the performance haptic stimulation device 116 as described above with respect to FIGS. 1-3 above.

For example, the controller may select the “Buzz” slide bar 306 on “effects” page 302 to control the haptic sexual stimulation device 116. The selected “Buzz” slide bar 306 may control the speed (and/or other parameters) of a vibrating motor of the haptic stimulation device 116. Alternatively, the controller may select the “Twirl” slide bar 310 on “effects” page 302 to control the haptic stimulation device 116. The selected “Twirl” slide bar 310 may control the speed (and/or other parameters) of a twirling motor of the haptic stimulation device 116. The selections made by the controller may then be transmitted from the web browser 124 to the server device 120 and then to the control application 112 on local computing device 110 for control of haptic stimulation device 116.

At operation 412, the control application 112 may control the haptic stimulation device 116 to perform the haptic stimulation effect as selected by the controller via web browser 124. As noted above, the control application may be connected to the haptic stimulation device 116 via a short range wireless communication protocol in order to control the operation of the haptic stimulation device 116.

At operation 414, final operations for browser-based control of the haptic stimulation device 116 may be performed. For example, the controller and/or the requester may choose to end the remote sexual stimulation session.

FIG. 5 is a flow diagram of a method 500 for browser-based control of a haptic stimulation device 116, according to embodiments of the present disclosure.

At operation 502, method 500 may continue from operation 408 of FIG. 4 after the requested web browser session key has been received for provision to a user of a web browser for control of the haptic stimulation device 116.

At operation 504, a command to perform a haptic stimulation routine may be received from the controller via the controls for haptic stimulation effects 126 and/or haptic stimulation routines 128 on the web page hosted by server 120.

As noted above, the controller may enter the unique URL session key into web browser 124 of remote computing device 122 which may be connected to the internet via communication network 118. The web browser 124 may load the remote sexual stimulation web page hosted by server device 120 in order to access the controls for haptic stimulation effects 126 and/or haptic stimulation routines 128 for the haptic stimulation device 116. The controller may then use the controls to command the performance haptic stimulation device 116 as described above with respect to FIGS. 1-3 above.

For example, the controller may select a “Buzz” routine on “routines” page 314 to control the haptic sexual stimulation device 116. The selected “Buzz” routine may control a pattern, intensity and/or duration of the vibrating motor of the haptic stimulation device 116. Alternatively, the controller may select a “Twirl” routine on “routines” page 314 to control the haptic stimulation device 116. The selected “Twirl” routine may control a pattern, intensity and/or duration of the twirling motor of the haptic stimulation device 116. The selections made by the controller may then be transmitted from the web browser 124 to the server device 120 and then to the control application 112 on local computing device 110.

At operation 506, a pattern, intensity, and/or a duration of a haptic stimulation effect to be executed by haptic stimulation device 116 may be determined by the control application 112 based on the haptic stimulation routine selected by the controller via the controls provided on web browser 124. As noted above, the routines may provide the requester and/or the controller with the ability to quickly command the haptic stimulation device 116 to perform complex combinations of haptic stimulation effects and/or parameters.

At operation 508, the control application 112 may control the haptic stimulation device 116 to perform the haptic stimulation routine as selected by the controller via the web browser 124. As noted above, the control application may be connected to the haptic stimulation device 116 via a short range wireless communication protocol in order to control the operation of the haptic stimulation device 116.

At operation 510, the method 500 may continue to operation 414 of method 400 for the performance of any final operations for the browser-based control of the haptic stimulation device 116.

### Computing Device

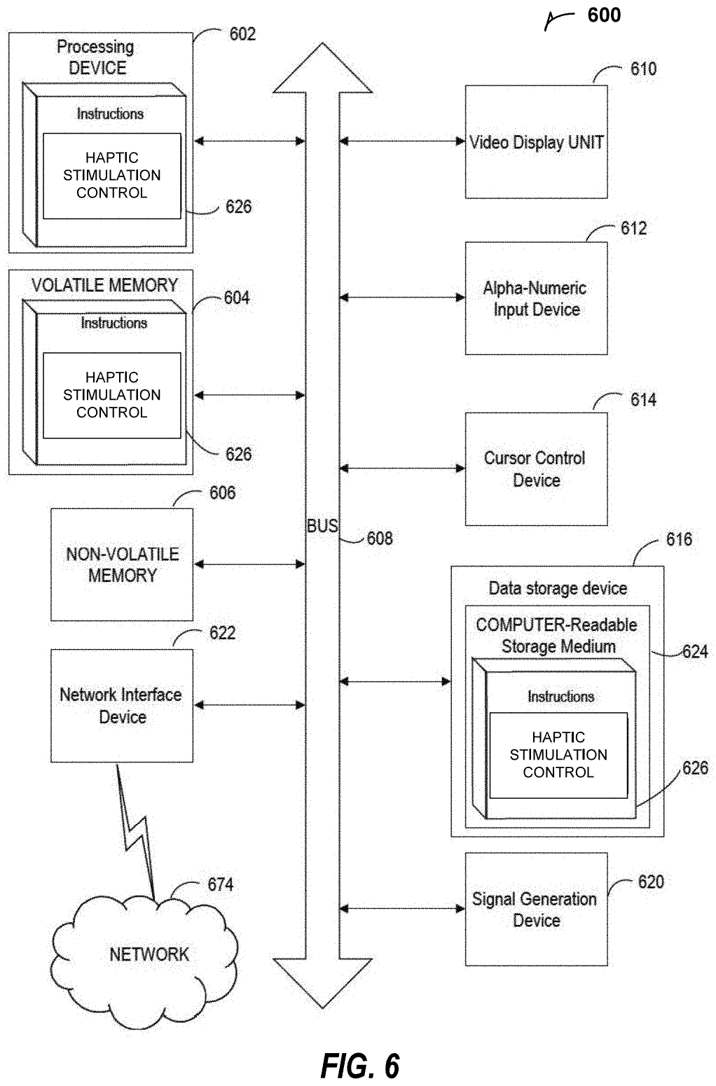

FIG. 6 depicts a block diagram of a computer system 600 operating in accordance with one or more aspects of the present disclosure. In various illustrative examples, computer system 600 may correspond to the local computing device 110 of FIG. 1.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions for haptic stimulation control by web browser 124 of FIG. 1 by implementing method 400 of FIG. 4.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components or in computer programs.

### Languge

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods 400 and 500 and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A computer implemented method for browser-based control of a haptic stimulation device, comprising:
receiving, by a computing device, a request for remote control of the haptic stimulation device;
requesting, by the computing device, a unique web browser session key for a web page with controls for the haptic stimulation device;
receiving, by the computing device, the requested session key for provision of the key to a user of a web browser;
receiving, by the computing device via the controls on the web page, a command from the user to perform a haptic stimulation effect; and
controlling, by the computing device, the haptic stimulation device to perform the haptic stimulation effect.

2. The method of claim 1, wherein the unique web browser session key includes a universal resource locator (URL) ending with a unique sequence.

3. The method of claim 1, wherein the haptic stimulation effect includes a suction effect.

4. The method of claim 1, wherein the haptic stimulation effect includes a thrust effect.

5. The method of claim 1, wherein the haptic stimulation effect includes a twirl effect.

6. The method of claim 1, wherein the computing device controls the haptic stimulation device using a wireless communication protocol.

7. The method of claim 1, further comprising:
receiving, by the computing device via the controls on the web page, a command from the user to perform a haptic stimulation routine; and
controlling, by the computing device, the haptic stimulation device to perform the haptic stimulation routine.

8. The method of claim 7, wherein the haptic stimulation routine includes at least one of a haptic stimulation pattern, a haptic stimulation intensity or a haptic stimulation duration, associated with the haptic stimulation effect.

9. The method of claim 8, further comprising:
determining, by the computing device, that the performance of the routine should be limited based on an override condition, wherein:
the override condition is based on at least one of a capability of the haptic stimulation device or a user configuration of the stimulation device.

10. A system for browser-based control of a haptic stimulation device, comprising:
a computing device, communicatively coupled to the haptic stimulation device, to:
receive a request for remote control of the haptic stimulation device;
request a unique web browser session key for a web page with controls for the haptic stimulation device;
receive the requested session key for provision of the key to a user of a web browser;
receive a command, from the user via the controls on the web page, to perform a haptic stimulation effect; and
control the haptic stimulation device to perform the haptic stimulation effect.

11. The system of claim 10, wherein the unique web browser session key includes a universal resource locator (URL) ending with a unique sequence.

12. The system of claim 10, wherein the haptic stimulation effect includes at least one of a suction, a thrust or a twirl.

13. The system of claim 10, wherein the computing device controls the haptic stimulation device using a wireless communication protocol

14. The system of claim 10, the computing device further to:
receive a command, from the user via the controls on the web page, to perform a haptic stimulation routine; and
control the haptic stimulation device to perform the haptic stimulation routine.

15. The system of claim 14, wherein the haptic stimulation routine includes at least one of a haptic stimulation pattern, a haptic stimulation intensity or a haptic stimulation duration associated with the haptic stimulation effect.

16. A computer readable medium (CRM) storing instructions which, when executed, cause one or more processors to perform operations for video game control of a haptic stimulation device, the operations comprising:
receiving a request for remote control of the haptic stimulation device;
requesting a unique web browser session key for a web page with controls for the haptic stimulation device;
receiving the requested session key for provision of the key to a user of a web browser;
receiving a command, from the user via the controls on the web page, to perform a haptic stimulation effect; and
controlling the haptic stimulation device to perform the haptic stimulation effect.

17. The CRM of claim 16, wherein the unique web browser session key includes a universal resource locator (URL) ending with a unique sequence.

18. The CRM of claim 16, wherein the haptic stimulation effect includes at least one of a suction, a thrust or a twirl.

19. The CRM of claim 16, the operations further comprising:
receiving a command, from the user via the controls on the web page, to perform a haptic stimulation routine; and
controlling the haptic stimulation device to perform the haptic stimulation routine.

20. The CRM of claim 19, wherein the haptic stimulation routine includes at least one of a haptic stimulation pattern, a haptic stimulation intensity or a haptic stimulation duration associated with the haptic stimulation effect.
